(19) United States
(12) Patent Application Publication
(10) Pub. No.: US 2004/0062142 A1
(43) Pub. Date: Apr. 1, 2004

(54) Systems and methods for the fabrication and evaluation of arrays of electrode and electrolyte materials for use in solid oxide fuel cells

(76) Inventors: Chang Wei, Niskayuna, NY (US); John Lemmon, Schoharic, NY (US); Susan Townsend, Niskayuna, NY (US)

Correspondence Address: DOUGHERTY, CLEMENTS & HOFER, 1901 ROXBOROUGH ROAD, SUITE300, CHARLOTTE, NC, 28211, US

(21) Appl. No.: 10/261,247

(22) Filed: Sep. 30, 2002

(51) Int. Cl. B01F 15/02

(52) U.S. Cl. 366/177.1; 366/184

(57) ABSTRACT

A system and associated methods for the fabrication and evaluation of an array of electrode or electrolyte materials for use in a solid oxide fuel cell, the system including a material handling device operable for individually containing a plurality of materials, a mixing device operable for mixing the plurality of materials to form a plurality of combinations of the plurality of materials, and a material delivery device operable for delivering a predetermined one of the plurality of combinations of the plurality of materials to each of a plurality of regions of a substrate, wherein the plurality of regions of the substrate form an array. The system also including a temperature control device operable for heating the array, thereby sintering the array. The system further including one or more sampling mechanisms operable for gathering performance data from each of the plurality of regions of the substrate and a testing device operably coupled to the one or more sampling mechanisms, wherein the testing device is operable for receiving the performance data associated with each of the plurality of regions of the substrate and evaluating the relative performance of each of the plurality of regions of the substrate.

### FIELD OF THE INVENTION

The present invention relates generally to solid oxide fuel cells and associated large-scale power generation, distributed power, and vehicular applications. More specifically, the present invention relates to systems and methods for the fabrication and evaluation of arrays of electrode and electrolyte materials for use in solid oxide fuel cells.

### BACKGROUND OF THE INVENTION

A solid oxide fuel cell (“SOFC”) is an electrochemical device that may be used in, for example, large-scale power generation, distributed power, and vehicular applications. One of the key challenges in developing a SOFC is developing high-performance electrode and electrolyte materials that meet SOFC performance and cost requirements. While there are lists of potential candidate materials for both electrodes and electrolytes, significant efforts are required to optimize material combinations, chemical compositions, processing conditions, and the like. This is especially true as the vast majority of such potential candidate materials are either ternary or quaternary-based.

For example, yttria-stabilized zirconia (“YSZ”) is commonly used as an electrolyte material in SOFCs. However, electrolyte performance is relatively sensitive to the ratio of Y to Zr, and this component ratio must be carefully optimized. The same is true with respect to other potential candidate materials for electrolytes, including Sr-doped CeO2, CGO, and the like. Electrode material composition is also critical to the performance of a SOFC. For example, the composition of LaxSr1xMnO (3) (“LSM”), a common cathode material, may greatly affect its electrical conductivity and electrochemical activity.

Typically, a plurality of combinations of elements or components with varying chemical compositions are individually formulated and tested in order to achieve optimal performance for electrode and electrolyte materials, a relatively slow, labor-intensive, and costly process. Thus, what is needed are high-throughput systems and methods that make SOFC-related materials development more efficient.

### BRIEF SUMMARY OF THE INVENTION

The present invention provides systems and methods that use a combinatorial electrochemistry approach to achieve the high-throughput fabrication and evaluation of arrays of electrode and electrolyte materials for use in solid oxide fuel cells (“SOFCs”). Advantageously, the present invention provides systems and methods that allow for the design of arrays of insulated electrodes, the preparation of electrode and electrolyte samples with controlled material compositions, and the multi-channel testing of those samples.

In one embodiment of the present invention, a system for the fabrication and evaluation of an array of electrode or electrolyte materials for use in a solid oxide fuel cell includes a material handling device operable for individually containing a plurality of materials; a mixing device operable for mixing the plurality of materials to form a plurality of combinations of the plurality of materials; a material delivery device operable for delivering a predetermined one of the plurality of combinations of the plurality of materials to each of a plurality of regions of a substrate, wherein the plurality of regions of the substrate form an array; a temperature control device operable for heating the array, thereby sintering the array; one or more sampling mechanisms operable for gathering performance data from each of the plurality of regions of the substrate; and a testing device operably coupled to the one or more sampling mechanisms, wherein the testing device is operable for receiving the performance data associated with each of the plurality of regions of the substrate and evaluating the relative performance of each of the plurality of regions of the substrate.

In another embodiment of the present invention, a method for the fabrication and evaluation of an array of electrode or electrolyte materials for use in a solid oxide fuel cell includes individually containing a plurality of materials; mixing the plurality of materials to form a plurality of combinations of the plurality of materials; delivering a predetermined one of the plurality of combinations of the plurality of materials to each of a plurality of regions of a substrate, wherein the plurality of regions of the substrate form an array; heating the array, thereby sintering the array; gathering performance data from each of the plurality of regions of the substrate; and receiving the performance data associated with each of the plurality of regions of the substrate and evaluating the relative performance of each of the plurality of regions of the substrate.

### BRIEF DESCRIPTION OF THE DRAWINGS

FIG. 1 is a schematic diagram of one embodiment of a system for the fabrication of an array of electrode or electrolyte materials for use in solid oxide fuel cells (“SOFCs”);

FIG. 2 is a schematic diagram of one embodiment of a system for the evaluation of an array of electrode or electrolyte materials for use in SOFCs; and

FIG. 3 is a flow chart of one embodiment of a method for the fabrication and evaluation of an array of electrode or electrolyte materials for use in SOFCs.

### DETAILED DESCRIPTION OF THE INVENTION

The present invention provides systems and methods that use a combinatorial electrochemistry approach to achieve the high-throughput fabrication and evaluation of arrays of electrode and electrolyte materials for use in solid oxide fuel cells (“SOFCs”). The present invention provides systems and methods that allow for the design of arrays of insulated electrodes, the preparation of electrode and electrolyte samples with controlled material compositions, and the multi-channel testing of those samples.

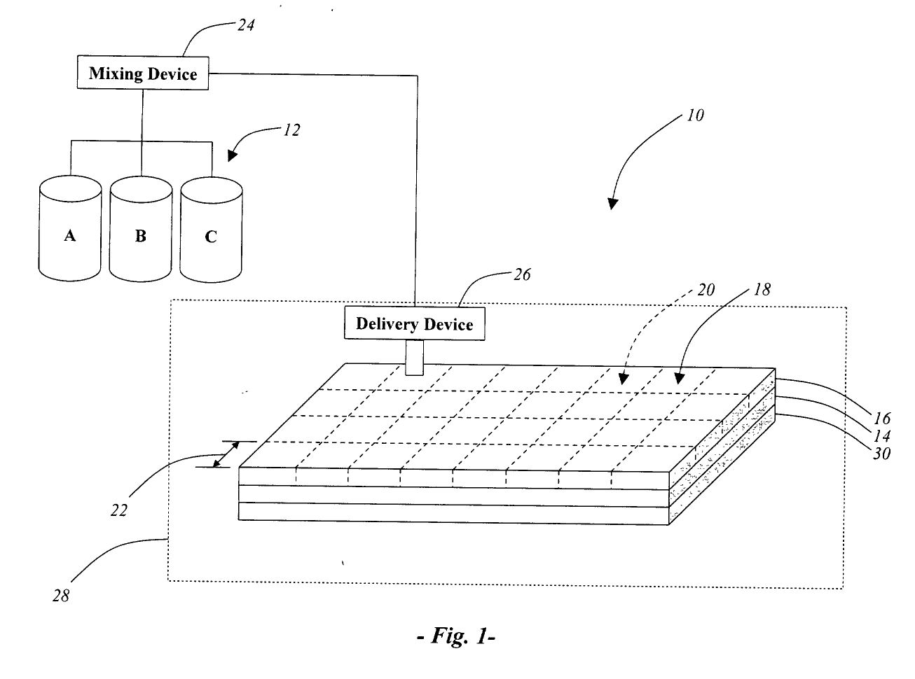

Referring to FIG. 1, in one embodiment of the present invention, a system 10 for the fabrication of an array of electrode or electrolyte materials for use in SOFCs includes a plurality of materials 12 (materials A, B, and C are shown) suitable for delivery to the surface of a substrate 14. The plurality of materials 12 may form a coating 16 on the surface of the substrate 14 or, alternatively, they may infiltrate the substrate 14, forming an array 18 of electrode or electrolyte materials suitable for evaluation. The plurality of materials 12 may form the array 18 of electrode or electrolyte materials by selectively altering the chemical composition and/or physical microstructure of each of a plurality of regions 20 of the substrate 14. Thus, the plurality of materials 12 may form, for example, a discrete array of electrode materials separated by electrolyte material, a continuous array of electrode materials, a discrete array of electrolyte materials, a continuous array of electrolyte materials, or any combination thereof. Optionally, the electrode material(s) and the electrolyte material(s) may be integrally formed with the substrate 14. Each of the plurality of regions 20 of the substrate 14 may be between about 1 mm and about 1 cm in height/width 22, although other suitable dimensions may be utilized.

The plurality of materials 12 may include, for example, a plurality of materials suitable for providing predetermined metal ions or combinations of metal ions to the surface of the substrate 14, such as metal oxides, metal carbonates, and the like (transition metals, rare earths, alkaline metals, alkaline earth metals, oxides, mixtures of oxides, and mixtures of metals). The substrate 14 may be an electrode material, an electrolyte material, or a sacrificial material. The substrate 14 may be porous or dense yttria-stabilized zirconia (“YSZ”), a green ceramic or polymer, or the like. For the evaluation of electrode materials for use in SOFCs, a Fe—Cr alloy or a conductive ceramic or metal, such as LaCrO3 or platinum, may be used for the array electrodes. For the evaluation of electrolyte materials for use in SOFCs, a conductive material or metal, such as a LaxSr1-xMnO (3) (“LSM”)-coated Fe—Cr alloy, LaCrO3, or platinum, may be used for the counter-electrode. Other suitable materials known to those of ordinary skill in the art may also be used for both the array electrodes, the array electrolytes, and the counter-electrodes. The plurality of materials 12 may further include binders and/or carrier materials to enhance the coating and/or infiltrating processes.

Prior to being delivered to the surface of the substrate 14, the plurality of materials 12, or precursor components, are mixed using a mixing device 24. The mixing device 24 may include a mixing-T, one or more tubes incorporating one or more baffles, a variable-speed rotary mixer, a screw mixer, a sonic mixer, or the like. The plurality of materials 12 are delivered to the surface of the substrate 14 using a delivery device 26 and, optionally, a masking device (not shown). The delivery device 26 may include, for example, a syringe, a pipette, a micro-dispenser, a liquid coating device, a spin coating device, a dip coating device, an elongate coating head, a powder coating device, a vapor coating device, an infiltration device, or any other dispensing or coating device known to those of ordinary skill in the art. Preferably, the delivery device 26 is movable relative to the surface of the substrate 14, either via movement of the delivery device 26 or via movement of the substrate 14 (such as through the use of a movable stage (not shown) or the like). Thus, predetermined combinations of the plurality of materials 12 may be selectively delivered to predetermined regions 20 of the substrate. These predetermined combinations of the plurality of materials 12 may be formed by selectively controlling the flow rates of each of the plurality of materials 12 to the mixing device 24 and/or the delivery device 26. Thus, the predetermined combinations of the plurality of materials 12 may vary discretely or continuously as a function of substrate position.

The system 10 for the fabrication of an array of electrode or electrolyte materials for use in SOFCs may also include a temperature control device 28 for heating the array 18 of electrode or electrolyte materials, thereby sintering the array 18 of electrode or electrolyte materials to remove any binders and/or carrier materials prior to SOFC assembly and evaluation.

The system 10 for the fabrication of an array of electrode or electrolyte materials for use in SOFCs may further include a counter-electrode 30 disposed adjacent to the substrate 14 (i.e., the electrolyte or array of electrolytes) and the electrode or array of electrodes, allowing for the combinatorial evaluation of an array of SOFCs. For example, the counter-electrode 30 may consist of an anode disposed adjacent to the electrolyte, the electrolyte disposed between the anode and an array of electrodes consisting of an array of cathodes.

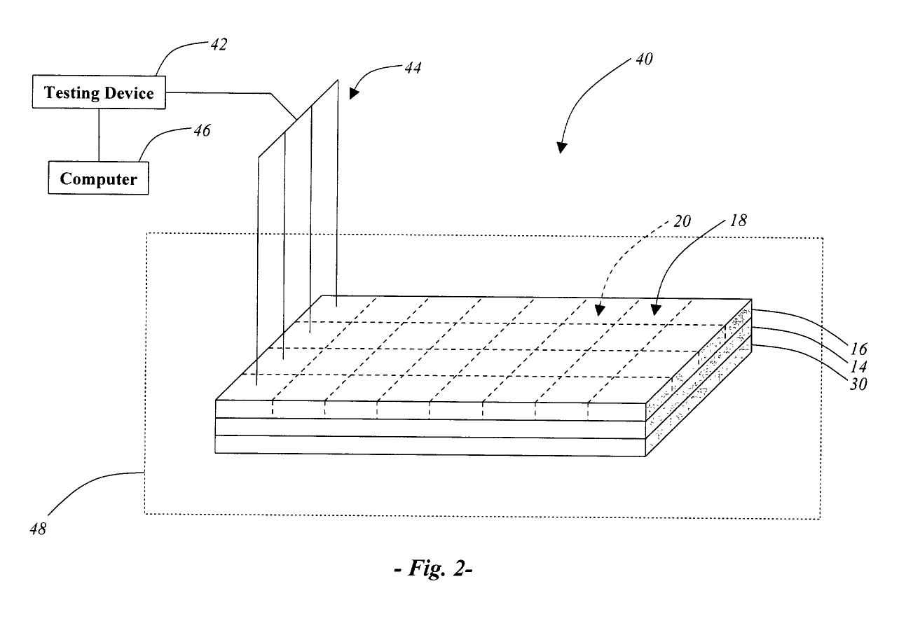

Referring to FIG. 2, in another embodiment of the present invention, a system 40 for the evaluation of an array of electrode or electrolyte materials for use in SOFCs includes the substrate 14, the coating 16 or infiltration layer (not shown), and the counter-electrode 30 described above, the substrate 14 and the coating 16 or infiltration layer forming the array 18 of electrode or electrolyte materials (or the array 18 of SOFCs in combination with the counter-electrode 30).

Preferably, the system 40 for the evaluation of an array of electrode or electrolyte materials for use in SOFCs also includes a testing device 42 operably coupled to each of the plurality of regions 20 of the substrate 14 (i.e., members of the array 18) via one or more leads, probes, sensors, or the like, referred to herein as one or more sampling mechanisms 44. The testing device 42 gathers data from the one or more sampling mechanisms 42 and, optionally, in combination with a computer 46, evaluates and compares the relative performance of each member of the array 18. The testing device 42 and the computer 46 may comprise a multi-channel electrochemical workstation capable of sampling each member of the array 18 in series or in parallel. For the evaluation of electrode materials for use in SOFCs, electrical resistance, potential, current or the like may be measured, evaluated, and compared. For example, potential may be measured using a current approach. Current may be measured using a constant-voltage approach. For the evaluation of electrolyte materials for use in SOFCs, ionic resistance, open circuit voltage, or the like may be measured, evaluated, and compared using an alternating-current (“AC”) impedance analyzer, a potentiastat, or the like. Preferably, with respect to the measurement of ionic resistance, it is measured using electrochemical impedance spectroscopy at a single frequency. Other measurement, evaluation, and comparison tools and techniques related to the performance of electrodes, electrolytes, and SOFCs are known to those of ordinary skill in the art and may be implemented in conjunction with the systems and methods of the present invention. Such tools and techniques may also be implemented in conjunction with an environmental control device 48 operable for isolating the array 18 of electrodes, electrolytes, or SOFCs from the surrounding environment.

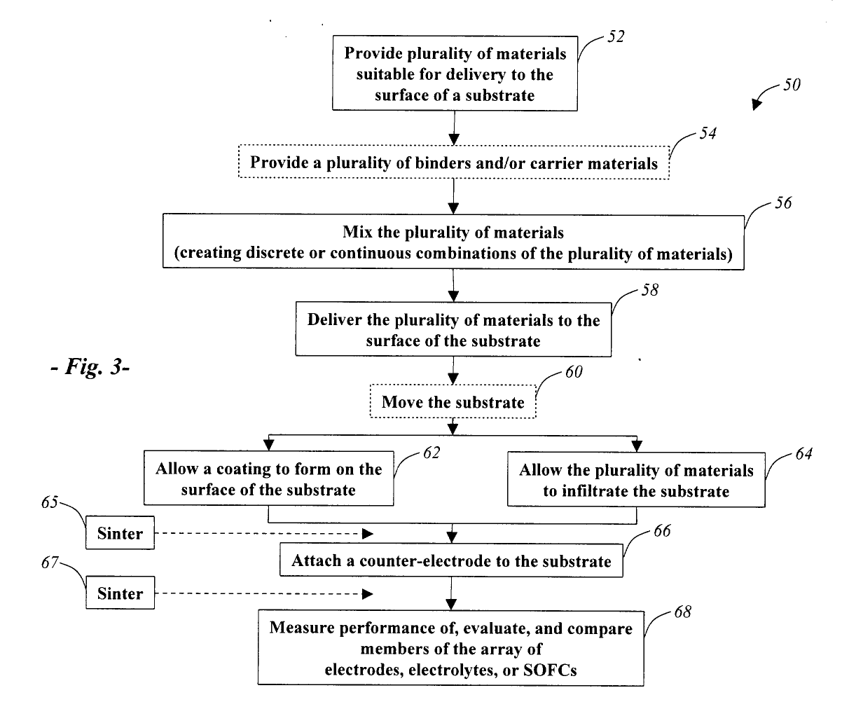

Referring to FIG. 3, in a further embodiment of the present invention, a method 50 for the fabrication and evaluation of an array of electrode or electrolyte materials for use in SOFCs includes providing a plurality of materials suitable for delivery to the surface of a substrate. (Block 52). As described above, the plurality of materials may form a coating on the surface of the substrate or, alternatively, they may infiltrate the substrate, forming an array of electrode or electrolyte materials suitable for evaluation. (See Blocks 62 and 64). The plurality of materials may form the array of electrode or electrolyte materials by selectively altering the chemical composition and/or physical microstructure of each of a plurality of regions of the substrate. Thus, the plurality of materials may form, for example, a discrete array of electrode materials separated by electrolyte material, a continuous array of electrode materials, a discrete array of electrolyte materials, a continuous array of electrolyte materials, or any combination thereof. The method 50 may also include providing a plurality of binders and/or carrier materials to enhance the coating and/or infiltrating processes. (Block 54).

Prior to being delivered to the surface of the substrate, the plurality of materials, or precursor components, are mixed using a mixing device. (Block 56). As described above, the mixing device may include a mixing-T, one or more tubes incorporating one or more baffles, a variable-speed rotary mixer, a screw mixer, a sonic mixer, or the like. The plurality of materials are then delivered to the surface of the substrate using a delivery device and, optionally, a masking device. (Block 58). As described above, the delivery device may include, for example, a syringe, a pipette, a micro-dispenser, a liquid coating device, a spin coating device, a dip coating device, an elongate coating head, a powder coating device, a vapor coating device, an infiltration device, or any other dispensing or coating device known to those of ordinary skill in the art. Preferably, the delivery device is movable relative to the surface of the substrate, either via movement of the delivery device or via movement of the substrate (such as through the use of a movable stage or the like). (Block 60). Thus, predetermined combinations of the plurality of materials may be selectively delivered to predetermined regions of the substrate. These predetermined combinations of the plurality of materials may be formed by selectively controlling the flow rates of each of the plurality of materials to the mixing device and/or the delivery device. Thus, the predetermined combinations of the plurality of materials may vary discretely or continuously as a function of substrate position.

As described above, the system for the fabrication of an array of electrode or electrolyte materials for use in SOFCs may also include a temperature control device for heating the array of electrode or electrolyte materials, thereby sintering the array of electrode or electrolyte materials to remove any binders and/or carrier materials prior to SOFC assembly and evaluation. (Blocks 65 and 67).

The method 50 for the fabrication and evaluation of an array of electrode or electrolyte materials for use in SOFCs may further include attaching a counter-electrode to the substrate (i.e., the electrolyte or array of electrolytes) and the electrode or array of electrodes, allowing for the combinatorial evaluation of an array of SOFCs. (Block 66). As described above, the counter-electrode may consist of an anode disposed adjacent to the electrolyte, the electrolyte disposed between the anode and an array of electrodes consisting of an array of cathodes.

In another embodiment of the present invention, the method 50 for the fabrication and evaluation of an array of electrode or electrolyte materials for use in SOFCs includes operably coupling a testing device to each of the plurality of regions of the substrate (i.e., members of the array) via one or more leads, probes, sensors, or the like, referred to herein as one or more sampling mechanisms. The testing device gathers data from the one or more sampling mechanisms and, optionally, in combination with a computer, evaluates and compares the relative performance of each member of the array. (Block 68) As described above, the testing device and the computer may comprise a multi-channel electrochemical workstation capable of sampling each member of the array in series or in parallel. For the evaluation of electrode materials for use in SOFCs, electrical resistance, ionic resistance, potential, current, or the like may be measured, evaluated, and compared. For example, potential may be measured using a constant-current approach. Current may be measured using a constant-voltage approach. For the evaluation of electrolyte materials for use in SOFCs, ionic resistance, open circuit voltage, or the like may be measured, evaluated, and compared using an AC impedance analyzer, a potentiastat, or the like. Preferably, with respect to the measurement of ionic resistance, it is measured using electrochemical impedance spectroscopy at a single frequency or multiple frequencies. Other measurement, evaluation, and comparison tools and techniques related to the performance of electrodes, electrolytes, and SOFCs are known to those of ordinary skill in the art and may be implemented in conjunction with the systems and methods of the present invention. Such tools and techniques may also be implemented in conjunction with an environmental control device operable for isolating the array of electrodes, electrolytes, or SOFCs from the surrounding environment.

It is apparent that there have been provided, in accordance with the systems and methods of the present invention, high-throughput techniques for the fabrication and evaluation of arrays of electrode and electrolyte materials for use in solid oxide fuel cells. Although the systems and methods of the present invention have been described with reference to preferred embodiments and examples thereof, other embodiments and examples may perform similar functions and/or achieve similar results. All such equivalent embodiments and examples are within the spirit and scope of the present invention and are intended to be covered by the following claims.

What is claimed is:

1. A system for the fabrication and evaluation of an array of electrode or electrolyte materials for use in a solid oxide fuel cell, the system comprising:
a material handling device operable for individually containing a plurality of materials;
a mixing device operable for mixing the plurality of materials to form a plurality of combinations of the plurality of materials; and
a material delivery device operable for delivering a predetermined one of the plurality of combinations of the plurality of materials to each of a plurality of regions of a substrate, wherein the plurality of regions of the substrate form an array.

2. The system of claim 1, wherein the material handling device is further operable for delivering a predetermined amount of each of the plurality of materials to the mixing device.

3. The system of claim 2, wherein the predetermined amount of each of the plurality of materials delivered to the mixing device varies as a function of time.

4. The system of claim 1, wherein each of the plurality of materials comprises a material selected from the group consisting of transition metals, rare earths, alkaline metals, alkaline earth metals, oxides, mixtures of oxides, and mixtures of metals.

5. The system of claim 1, wherein the plurality of materials comprise a binder.

6. The system of claim 1, wherein the plurality of materials comprise a carrier material.

7. The system of claim 1, wherein the substrate comprises a substrate selected from the group consisting of a non-sintered ceramic, a partially-sintered ceramic, and a polymer.

8. The system of claim 1, wherein each of the plurality of combinations of the plurality of materials alter the chemical composition of each of the plurality of regions of the substrate.

9. The system of claim 1, wherein each of the plurality of combinations of the plurality of materials alter the physical microstructure of each of the plurality of regions of the substrate.

10. The system of claim 1, wherein the predetermined one of the plurality of combinations of the plurality of materials delivered to each of the plurality of regions of the substrate varies as a function of substrate position.

11. The system of claim 1, further comprising a temperature control device operable for heating the array, thereby sintering the array.

12. The system of claim 1, further comprising one or more sampling mechanisms operable for gathering performance data from each of the plurality of regions of the substrate.

13. The system of claim 12, further comprising a testing device operably coupled to the one or more sampling mechanisms, wherein the testing device is operable for receiving the performance data associated with each of the plurality of regions of the substrate and evaluating the relative performance of each of the plurality of regions of the substrate.

14. The system of claim 1, wherein the array comprises an array of materials selected from the group consisting of electrode materials and electrolyte materials.

15. The system of claim 1, wherein the array comprises an array of solid oxide fuel cells.

16. A system for the fabrication and evaluation of an array of electrode or electrolyte materials for use in a solid oxide fuel cell, the system comprising:
a material handling device operable for individually containing a plurality of materials;
a mixing device operable for mixing the plurality of materials to form a plurality of combinations of the plurality of materials;
a material delivery device operable for delivering a predetermined one of the plurality of combinations of the plurality of materials to each of a plurality of regions of a substrate, wherein the plurality of regions of the substrate form an array;
a temperature control device operable for heating the array, thereby sintering the array;
one or more sampling mechanisms operable for gathering performance data from each of the plurality of regions of the substrate; and
a testing device operably coupled to the one or more sampling mechanisms, wherein the testing device is operable for receiving the performance data associated with each of the plurality of regions of the substrate and evaluating the relative performance of each of the plurality of regions of the substrate.

17. The system of claim 16, wherein the material handling device is further operable for delivering a predetermined amount of each of the plurality of materials to the mixing device.

18. The system of claim 17, wherein the predetermined amount of each of the plurality of materials delivered to the mixing device varies as a function of time.

19. The system of claim 16, wherein each of the plurality of materials comprises a material selected from the group consisting of transition metals, rare earths, alkaline metals, alkaline earth metals, oxides, mixtures of oxides, and mixtures of metals.

20. The system of claim 16, wherein the plurality of materials comprise a binder.

21. The system of claim 16, wherein the plurality of materials comprise a carrier material.

22. The system of claim 16, wherein the substrate comprises a substrate selected from the group consisting of a non-sintered ceramic, a partially-sintered ceramic, and a polymer.

23. The system of claim 16, wherein each of the plurality of combinations of the plurality of materials alter the chemical composition of each of the plurality of regions of the substrate.

24. The system of claim 16, wherein each of the plurality of combinations of the plurality of materials alter the physical microstructure of each of the plurality of regions of the substrate.

25. The system of claim 16, wherein the predetermined one of the plurality of combinations of the plurality of materials delivered to each of the plurality of regions of the substrate varies as a function of substrate position.

26. The system of claim 16, wherein the array comprises an array of materials selected from the group consisting of electrode materials and electrolyte materials.

27. The system of claim 16, wherein the array comprises an array of solid oxide fuel cells.

28. A method for the fabrication and evaluation of an array of electrode or electrolyte materials for use in a solid oxide fuel cell, the method comprising:
individually containing a plurality of materials;
mixing the plurality of materials to form a plurality of combinations of the plurality of materials; and
delivering a predetermined one of the plurality of combinations of the plurality of materials to each of a plurality of regions of a substrate, wherein the plurality of regions of the substrate form an array.

29. The method of claim 28, further comprising delivering a predetermined amount of each of the plurality of materials to the mixing device.

30. The method of claim 29, wherein the predetermined amount of each of the plurality of materials delivered to the mixing device varies as a function of time.

31. The method of claim 28, wherein each of the plurality of materials comprises a material selected from the group consisting of transition metals, rare earths, alkaline metals, alkaline earth metals, oxides, mixtures of oxides, and mixtures of metals.

32. The method of claim 28, wherein the plurality of materials comprise a binder.

33. The method of claim 28, wherein the plurality of materials comprise a carrier material.

34. The method of claim 28, wherein the substrate comprises a substrate selected from the group consisting of a non-sintered ceramic, a partially-sintered ceramic, and a polymer.

35. The method of claim 28, wherein each of the plurality of combinations of the plurality of materials alter the chemical composition of each of the plurality of regions of the substrate.

36. The method of claim 28, wherein each of the plurality of combinations of the plurality of materials alter the physical microstructure of each of the plurality of regions of the substrate.

37. The method of claim 28, wherein the predetermined one of the plurality of combinations of the plurality of materials delivered to each of the plurality of regions of the substrate varies as a function of substrate position.

38. The method of claim 28, further comprising heating the array, thereby sintering the array.

39. The method of claim 28, further comprising gathering performance data from each of the plurality of regions of the substrate.

40. The method of claim 39, further comprising receiving the performance data associated with each of the plurality of regions of the substrate and evaluating the relative performance of each of the plurality of regions of the substrate.

41. The method of claim 28, wherein the array comprises an array of materials selected from the group consisting of electrode materials and electrolyte materials.

42. The method of claim 28, wherein the array comprises an array of solid oxide fuel cells.
